(19) United States
(12) Patent Application Publication
(10) Pub. No.: US 2010/0206447 A1
(43) Pub. Date: Aug. 19, 2010

(54) Pneumatic Tire

(75) Inventors: Toshiyuki Ohashi, Osaka (JP); Tetsuji Miyazaki, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/683,493

(22) Filed: Jan. 7, 2010

(30) Foreign Application Priority Data
Feb. 19, 2009 (JP) 2009-036704

(51) Int. Cl. B60C 11/12

(52) U.S. Cl. 152/209.25

(57) ABSTRACT

An object of the present invention is to provide a pneumatic tire that ensures both of the on-ice braking performance and the dry braking performance. In order to achieve the object, a pneumatic tire comprises a tread surface including a land portion in which a plurality of sipes are formed, wherein each of the sipes includes a reference plane extending in a depth direction of the sipe from a wavy or zigzag line in the surface of the land portion and each of the sipes is formed with a convex portion having a convex shape in a vertical section with respect to the reference plane in a top area at the front side and the rear side thereof.

### BACKGROUND OF THE INVENTION

1. Field of the Invention

The present invention relates to a pneumatic tire comprising a tread surface including a land portion in which a plurality of sipes is formed, particularly to a pneumatic tire useful as a winter tire.

2. Description of the Related Art

Conventionally, there are known winter tires in which many sipes are disposed in the respective portions (center portion, mediate portion and shoulder portion) of tire pattern in order to improve traveling performance on an iced road surface with a low friction coefficient (hereinafter, referred to as “on-ice performance”). By disposing many sipes extending in a width direction of tire in order to improve the braking performance on the iced road surface (hereinafter, referred to as “on-ice braking performance”), the edge effect in a longitudinal direction is improved. By forming such sipes in the land portion, edge effect, water removal effect and gripping effect are improved. Thus, the number of sipes tends to be increased in these years.

However, when the number of sipes is increased to increase the density of the sipes, although the number of edges increases, the rigidity of the entire land portion is reduced. As a result, such a problem occurs. That is, sipes are easily yielded adversely reducing the edge effect as well as the on-ice performance accordingly. Due to the reduced rigidity of the entire land portion, such a problem also occurs. That is, the braking performance on dry road surface (hereinafter, referred to as “dry braking performance”) is reduced. In this reason, recently so-called three-dimensional sipes draw attentions. In three-dimensional sipes, the configuration of sipes is changed in a depth direction to thereby ensure the rigidity of the entire land portion to suppress the yielding of sipes.

Japanese Unexamined Patent Publication No. 2006-298331 discloses a pneumatic tire having a plurality of blocks formed with three-dimensional sipes in a tread surface thereof. In the pneumatic tire having a plurality of blocks formed with sipes in the tread surface, each of the sipes has amplitude in a direction perpendicular to a longitudinal direction of the sipe at least at the side closer to the tread surface of the tire. Each of the sipes includes at least one portion the cross sectional configuration of which is different from that of the other portions as viewed in a depth direction of the tire. In each of the sipes, the configuration of the sipe at the side closer to the tread surface of the tire is identical to the configuration at the bottom thereof. In the above pneumatic tire of Japanese Unexamined Patent Publication No. 2006-298331, particularly, as the configuration different from the other portion, a concave shape having an inverted R shape is formed in a peak portion of the amplitude of the sipe. The present inventor et al., examined the above tire intensively. As a result, it was found that the above-described arrangement described in Japanese Unexamined Patent Publication No. 2006-298331 fails to satisfactorily ensure the rigidity of the entire block and to suppress the yielding of sipes. Accordingly, it was found that there was a room for improving the on-ice braking performance and the dry braking performance.

Japanese Unexamined Patent Publication No. 2001-294022 discloses a pneumatic tire having a plurality of blocks constituting a block pattern, in which all or a part of the plurality of blocks is formed with at least one sipe. In the pneumatic tire, a concave portion is formed between the sipes in a central area as viewed in a depth direction of the sipe as well as on a wall surface abutting on a sipe of a small block portion formed between a sipe and block edge and/or on a wall surface of the small block portion facing the wall surface. Japanese Unexamined Patent Publication No. 2007-21942 discloses a pneumatic tire having a tread pattern including a plurality of blocks formed with sipes. Each of the sipes has an opening edge, which is an edge of partially removed opening. Defining that, when the blocks are embedded in the pneumatic tire, the side closer to the carcass layer is the lower side, at least the cross section of the lower part in the opening edge becomes smaller toward the opening portion. However, any of the above pneumatic tires fails to ensure sufficient rigidity of the entire block and to suppress the yielding of sipes. Therefore, the on-ice braking performance and the dry braking performance tend to decrease.

### SUMMERY OF THE INVENTION

The present invention is made in view of the above-described circumstances. An object of the present invention is to provide a pneumatic tire that ensures both of the on-ice braking performance and the dry braking performance.

The above object can be achieved by the present invention as described below. That is, the present invention is directed to a pneumatic tire comprising a tread surface including a land portion in which a plurality of sipes are formed, wherein each of the sipes includes a reference plane extending in a depth direction of the sipe from a wavy or zigzag line in the surface of the land portion and each of the sipes is formed with a convex portion having a convex shape in a vertical section with respect to the reference plane in a top area at the front side and the rear side thereof.

According to the present invention, the sipe includes a reference plane extending in the depth direction of the sipe from the wavy or zigzag line in the land portion surface. Therefore, the merit of the so-called wavy sipe can be obtained. Also, convex portions having a convex shape in the vertical section are provided to both of the front and rear sides. Therefore, irrespective of the yielding direction of the sipe, little influence is given to the yielding suppression effect. At this time, since the convex portion having a convex shape in the vertical section becomes the engagement plane, a large engagement force can be obtained in depth direction of the sipe. Further, since the engagement plane having a convex shape with respect to the reference plane is provided in a top area thereof, a large engagement force can be obtained. With this arrangement, merit of the wavy sipe and sufficient engagement force can be obtained in the depth direction of the sipe. Moreover, irrespective of the yielding direction of the sipe, little influence is given to the yielding suppression effect. Since the yielding of the sipe can be suppressed, in the pneumatic tire according to the present invention, ground-contact area of the land portion can be prevented from being reduced due to a large yielding of the sipe, and the rigidity of the entire land portion can be satisfactorily ensured.

In the pneumatic tire according to the present invention, since the ground-contact area in the land portion can be prevented from being reduced and the rigidity of the entire land portion can be satisfactorily ensured, both of the on-ice braking performance and the dry braking performance can be increased.

In the above pneumatic tire, each of the sipes is preferably further formed with a concave portion having a concave shape in the vertical section with respect to the reference plane in a top area at the front side and the rear side thereof, the concave portion preferably includes a flat plane portion located at the convex portion side as viewed in the depth direction of the sipe extending in the width direction of the sipe, and the convex portion is preferably connected to the flat plane portion. With this arrangement, when the sipe yields at brake application, due to the flat plane portion of the concave portion formed in the sipe, since the engagement force in the depth direction of the sipe is increased, the yielding of the sipe can be suppressed more effectively than the conventional manner. Additionally, since the convex portion and the flat plane portion of the concave portion are connected to each other, the yielding suppression effect of the sipe can be increased. Therefore, the ground-contact area of the land portion can be prevented from being reduced more effectively than the conventional manner as well as the rigidity of the entire land portion can be increased. As a result, both of the on-ice braking performance and the dry braking performance of the pneumatic tire can be increased with this arrangement.

In the pneumatic tire, defining the ½ length of the amplitude of the wavy or zigzag line in the surface of the land portion as T, and maximum length of the flat plane portion in the sipe width direction as T1, the lengths are preferably set to a range of 1.1T≦T1≦2T. With this arrangement, the length of the flat plane portion in the width direction of the sipe is satisfactorily ensured and the engagement force in the depth direction of the sipe is remarkably increased. Accordingly, the yielding of the sipe can be reliably suppressed. Therefore, the ground-contact area in the land portion can be reliably prevented from being reduced and the rigidity of the entire land portion can be reliably increased. As a result, with this arrangement, both of the on-ice braking performance and the dry braking performance of the pneumatic tire can be remarkably increased.

In the pneumatic tire, the concave portion is preferably connected to the end of the flat plane located at the opposite side of the convex portion and preferably has a side wall having an arc-like shape in the cross section protruding to the width direction of the sipe. With this arrangement, satisfactory length can be ensured in the sipe width direction for the flat plane portion included in the concave portion of the sipe, and a large angle can be formed between the flat plane portion and the side wall. As a result, both of the on-ice braking performance and the dry braking performance of the pneumatic tire are increased and sipe blade for forming the sipe can be manufactured easily.

### BRIEF DESCRIPTION OF THE DRAWINGS

FIG. 1 is a front view illustrating an example of a tread surface of a pneumatic tire according to the present invention;

FIG. 2 is an enlarged perspective view illustrating a land portion of the pneumatic tire in FIG. 1, from which a part thereof is removed; FIG. 3 is a cross sectional view as viewed in a direction of arrow I-I of FIG. 2;

FIG. 4 is a cross sectional view as viewed in a direction of arrow II-II of FIG. 2;

FIGS. 5A to 5E are cross sectional views illustrating examples of sipes of other embodiments; and

FIG. 6 is a cross sectional view of a sipe formed in a pneumatic tire of Comparative Example 2.

### DETAILED DESCRIPTION OF THE PREFERRED EMBODIMENTS

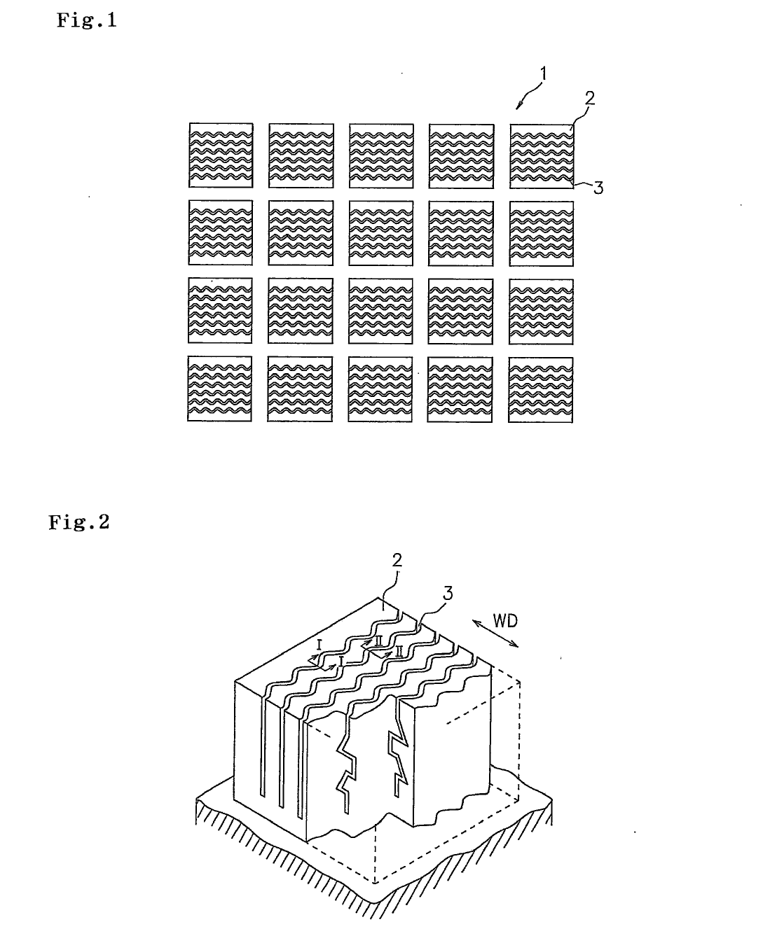

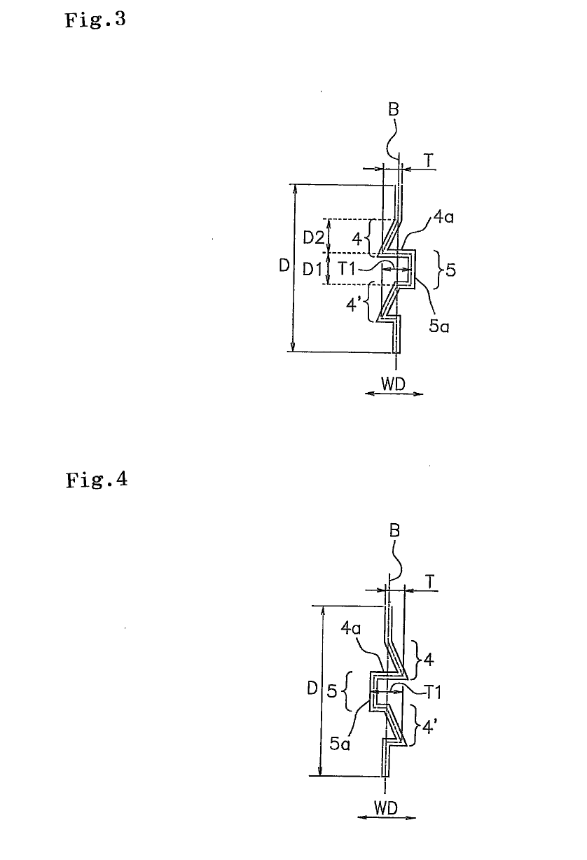

Preferred embodiments of the present invention will be described below. FIG. 1 is a front view illustrating an example of a tread surface of a pneumatic tire according to the present invention. FIG. 2 is an enlarged perspective view illustrating a land portion of the pneumatic tire in FIG. 1, from which a part thereof is removed. FIG. 3 is a cross sectional view as viewed in a direction of arrow I-I of FIG. 2. FIG. 4 is a cross sectional view as viewed in a direction of arrow II-II of FIG. 2. In FIGS. 2 to 4, reference symbol “WD” indicates a width direction of a sipe.

The pneumatic tire of the present invention has a land portion formed with a plurality of sipes in a tread surface thereof. This embodiment shows an example of a pneumatic tire that has a plurality of blocks 2 as the land portion in a tread surface 1 as shown in FIG. 1. As shown in FIG. 1, each of the blocks 2 is formed with a plurality of sipes 3 extending in a width direction of the tire (a right-left direction in FIG. 1). This embodiment shows an example in which six sipes 3 are formed in one block 2. However, the number of the sipes in one block is not particularly limited. In this embodiment, both ends of the respective sipes 3 are opened to the grooves abutting on the block 2, but not limited thereto. An appropriated arrangement may be employed depending on the configuration of the pattern. For example, both ends of the respective sipes 3 may be terminated at the inside of the side walls of the block 2 without being exposed to the grooves; or only one end of the respective sipes 3 may be terminated at the inside of side wall of the block 2.

Each sipe 3 of the present invention has a reference plane B extending in a depth direction of the sipe from a wavy or zigzag line on the surface of the block 2 as shown in FIGS. 3 and 4. The reference plane B has substantially the same cross sectional configuration at any depth. The wavy line is not limited to a substantially sinusoidal waveform. Any configuration such as a wavy line in a combination of a straight line and a curved line, or a substantially rectangular waveform may be employed.

The wave length of the wavy or zigzag line is preferably 1.5 to 4 mm in order to obtain preferable performance of the so-called wavy sipe, and the amplitude (sum of the height of the both peaks; equivalent to “2T” in FIGS. 3 and 4) is preferably 1 to 2 mm.

According to the present embodiment, the sipe 3 includes a concave portion 4 and a convex portion 5 in this order from the side closer to the tread surface of the block 2 in a front upper portion of the sipe 3. The concave portion 4 has a concave shape in a vertical section and the convex portion 5 has a convex shape in the vertical section with respect to the reference plane B as shown in FIG. 3. On the other hand, the sipe 3 includes a concave portion 4 and a convex portion 5 in this order from the side closer to the tread surface of the block 2 in a rear upper portion of the sipe 3. The concave portion 4 has a concave shape in the vertical section and convex portion 5 has a convex shape in the vertical section with respect to the reference plane B as shown in FIG. 4. In the present embodiment, the sipe 3 includes the convex portion 5 having a convex shape in the vertical section and the concave portion 4 having a concave shape in the vertical section at the both of the front side and the rear side of the sipe 3. Therefore, irrespective of the yielding direction of the sipe 3, little influence is given to the yielding suppression effect of the sipe 3. The sipe 3 of the present embodiment further has a second concave portion 4′ having a concave shape in the vertical section below the convex portion 5 as viewed in a depth direction of the sipe 3.

According to the present embodiment, the sipe 3 has the convex portions 5. The convex portions 5 protrude in the top areas of the front and rear sides of the sipe 3, and include a protruding flat portion 5a that is generally parallel to the base line of the tread surface of the block 2. With this arrangement, in the pneumatic tire of the present embodiment, a larger engagement force can be obtained in the depth direction of the sipe. Further, irrespective of the yielding direction of the sipe 3, little influence is given to the yielding suppression effect of the sipe 3.

According to the present embodiment, the sipe 3 further includes the concave portion 4. The concave portion 4 includes a flat plane portion 4a which is located at the convex portion 5 side as viewed in the depth direction of the sipe and extends in a width direction WD of the sipe. The flat plane portion 4a may extend in the width direction WD of the sipe parallel to the tread surface of the block 2 or with an inclination angle of 70° or less with respect to the tread surface of the block 2.

According to the present embodiment, the end of the protruding flat portion 5a of the convex portion 5 located at the side closer to the tread surface of the block 2 is connected to the end of the flat plane portion 4a of the concave portion 4. The concave portion 4 includes the flat plane portion 4a that extends in the width direction WD of the sipe, and the convex portion 5 and the concave portion 4 are connected to each other as described above. With this arrangement, when the sipe 3 yields due to applied brake or the like, the flat plane portion 4a of the concave portion 4 included in the sipe 3 increases the engagement force in the depth direction of the sipe. Thus the yielding of the sipe 3 can be suppressed more effectively and the ground-contact area of the block 2 can be prevented from being reduced more effectively and the rigidity of the entire block 2 can be increased. As a result, according to the present embodiment, both of the on-ice braking performance and the dry braking performance of the pneumatic tire can be further increased.

As shown in FIGS. 3 and 4, defining ½ length of the amplitude of the wavy line in the surface of the block 2 as “T”; and defining maximum length of the flat plane portion 4a of the concave portion 4 in the sipe width direction WD as “T1”, in this embodiment, the relationship therebetween is set as 1.1T≦T1≦2T. In this case, since the length of the flat plane portion 4a is ensured satisfactory in the width direction of the sipe, the engagement force in the depth direction of the sipe increases remarkably; thereby the yielding of the sipe 3 can be reliably suppressed. Therefore, the ground-contact area of the block 2 can be reliably prevented from being reduced and the rigidity of the entire land portion can be remarkably increased.

The length of the sipe 3 in the depth direction of the sipe “D” is preferably set to 5 to 13 mm. On the other hand, in order to effectively suppress the yielding of the sipe 3, the length “D1” of the convex portion 5 of the sipe 3 in the depth direction of the sipe is preferably set within a range of 0.1D≦D1≦0.3D. Likewise, in order to effectively suppress the yielding of the sipe 3, the length of the concave portion 4 of the sipe 3 in the depth direction of the sipe “D2” is preferably set in arrange of 0.1D≦D2≦0.3D.

In this invention, the corner of the convex portion 5 and the concave portion 4 of the sipe 3 is preferably formed in an arc-like shape in a cross section. With this arrangement, sipe blade for forming the sipe 3 can be manufactured easily, and the sipe blade can be easily pulled out from vulcanized tire. Particularly, in order to make the manufacture of the sipe blade with ease, and to easily pull-out the sipe blade, the corner of the convex portion 5 and the concave portion 4 of the sipe 3 is preferably formed in an arc-like shape in the cross section, and the curvature radius thereof is preferably set to 0.5 mm or less.

In the present invention, the smaller width of the sipe 3, the larger suppression effect of the yielding of the block 2 is obtained by the concave portion 4 and the convex portion 5. However, when the width of the sipe is too small, the edge is hardly generated and the edge effect decreases. Therefore, the width of the sipe 3 is preferably set to a range of 0.2 to 0.7 mm.

According to the present invention, a large yielding suppression effect of the block 2 is obtained by the concave portion 4 and the convex portion 5. Therefore, by increasing the number of the sipes to increase the sipe density, the number of edges is increased and the edge effect can be further increased. In this viewpoint, in the present invention, the sipe density is preferably set to 0.1 to 0.3 mm/mm², more preferably set to 0.15 to 0.3 mm/mm².

The pneumatic tire of the present invention is the same as the ordinal pneumatic tire excepting a point that the above-described sipes 3 are formed in the land portion. Therefore, conventionally known materials, shapes, structure, manufacture and the like are applicable to the present invention.

The pneumatic tire of the present invention provides the above described working and effect and superior in the on-ice performance; accordingly the pneumatic tire of the present invention is useful as a winter tire.

### Other Embodiments

(1) The foregoing embodiment describes an example of the pneumatic tire provided with the blocks 2 formed with a plurality of sipes 3 in the tread surface 1. According to the present invention, the pneumatic tire may be provided with ribs as the land portion formed with the sipes 3.

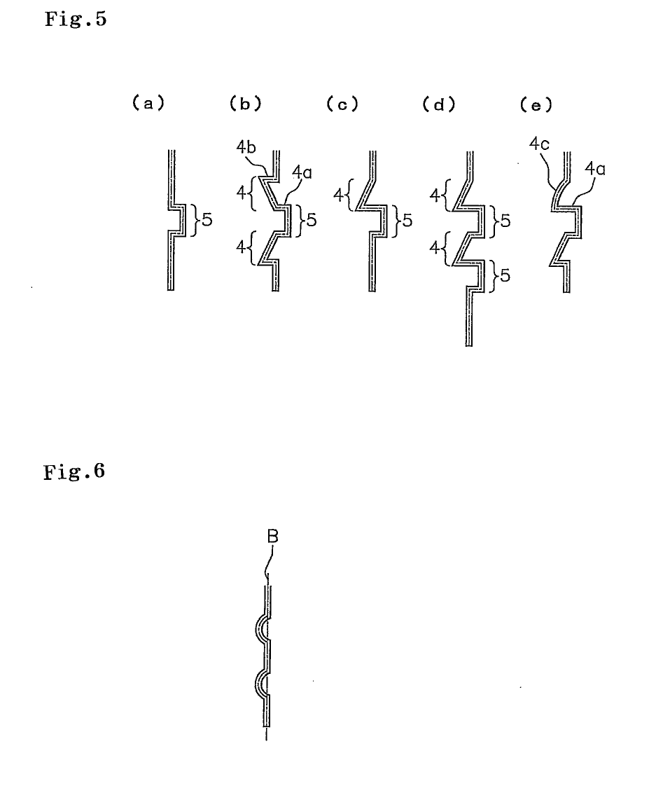

(2) The foregoing embodiment describes an example of the sipe 3 that includes, from the side closer to the tread surface of the block 2, the concave portion 4 having a concave shape in a vertical section and the convex portion 5 having a convex shape in the vertical section with respect to the reference plane B in a top area at the front and the rear sides thereof. However, according to the present invention, the sipe 3 may have only the convex portion 5 as shown in FIG. 5A. With this arrangement, a satisfactory engagement force can be obtained in the depth direction of the sipe, and irrespective of the yielding direction of the sipe 3, little influence is given to the yielding suppression effect. Therefore, when the sipe 3 includes only the convex portion 5, the ground-contact area of the land portion can be prevented from being reduced and satisfactory rigidity of the entire land portion is ensured.

(3) The foregoing embodiment describes an example in which the concave portion 4 includes the flat plane portion 4a that is located at the convex portion 5 side as viewed in the depth direction of the sipe and extends in the sipe width direction WD. However, according to the present invention, in addition to the flat plane portion 4a, the concave portion 4 may include a second flat plane portion 4b which is located at the opposite side of the convex portion 5 as viewed in the depth direction of the sipe and extends in the sipe width direction WD as shown in FIG. 5B.

(4) The foregoing embodiment describes an example of the sipe 3 that includes, from the side closer to the tread surface of the block 2, the concave portion 4 having a concave shape in the vertical section and the convex portion 5 having a convex shape in the vertical section with respect to the reference plane B in the top areas at the front and the rear sides thereof. However, according to the present invention, the sipe may have each of the concave portion 4 and the convex portion 5 as shown in FIG. 5C; or may include two concave portions 4 and convex portions 5 respectively as shown in FIG. 5D.

(5) According to the present invention, the concave portion 4 of the sipe 3 may be connected to the end of the flat plane portion 4a located at the opposite side to the convex portion 5, and may have a side wall 4c having an arc-like shape in a cross section protruding to the sipe width direction WD as shown in FIG. 5E. In this case, satisfactory length of the flat plane portion 4a of the concave portion 4 of the sipe 3 can be ensured in the sipe width direction and a large angle can be ensured between the flat plane portion 4a and the side wall 4c. As a result, both of the on-ice braking performance and the dry braking performance of the pneumatic tire can be increased, and the sipe blade for forming the sipe 3 can be manufactured with ease.

### Examples

Examples and Comparative Examples, which demonstrate structure and effect of the present invention, will be described below. Performance evaluation of tires was conducted as described below.

(1) On-Ice Braking Performance

Test tires (size 205/65R15) were mounted on an actual vehicle (3000 cc class FR sedan, made in Japan), with a load of one passenger, and driven on iced road surface. While driving the vehicle at a speed of 40 km/h, brake was applied and ABS was activated. Defining braking distance of conventional tires (Comparative Example 1) as 100, the braking distance was indicated with using an index to evaluate. As the value increases, the tire exhibited more satisfactory on-ice braking performance.

(2) Dry Braking Performance

Test tires (size 205/65R15) were mounted on an actual vehicle (3000 cc class FR sedan, made in Japan), with a load of one passenger, and driven on dry road surface (paved road). While driving the vehicle at a speed of 40 km/h, brake was applied and ABS was activated. Defining braking distance of conventional tires (Comparative Example 1) as 100, the braking distance was indicated with index to evaluate. As the value increases, the tire exhibited more satisfactory dry braking performance.

### Example 1

Pneumatic tires, each of which has a tread pattern shown in FIG. 1 and is formed with sipes 3 having a configuration shown in FIGS. 2 to 4, was prepared. The width of the sipe 3 was set to 0.3 mm; the depth D of the sipe 3 was set to 7 mm; ½ length T of the amplitude of the wavy line in the surface of the block 2 was set to 0.7 mm; maximum length T1 of the flat plane portion 4a of the concave portion 4 in the width direction of the sipe was set to 1.4 mm; the length D1 of the convex portion 5 in the depth direction of the sipe was set to 1.3 mm; and the length D2 of the concave portion 4 in the depth direction of the sipe was set to 1.3 mm. Using these tires, the above-described performance evaluation test was conducted. The test result is shown in Table 1.

### Comparative Example 1

Pneumatic tires, each of which had a tread pattern shown in FIG. 1 and the same structure as that of Example 1 excepting a point that the sipes 3 had no convex portion or concave portion, was prepared. Using these tires, the above-described performance evaluation test was conducted. The test result is shown in Table 1.

### Comparative Example 2

Pneumatic tires, each of which had a tread pattern shown in FIG. 1 and the same structure as that of Example 1 excepting a point that sipes were formed with only the concave portions having a concave shape in a vertical section with respect to the reference plane B as shown in FIG. 6 in the top areas at the front and the rear sides thereof. Using these tires, the above-described performance evaluation test was conducted. The test result is shown in Table 1.

TABLE 1

| | Comparative | Comparative | |
|---|---|---|---|
| | Example 1 | Example 2 | Example 1 |
| On-ice braking performance | 100 | 110 | 115 |
| Dry braking performance | 100 | 105 | 110 |

Test result in Table 1 demonstrates a fact that, compared to the pneumatic tire of Comparative Example 1, the on-ice braking performance and the dry braking performance of the pneumatic tire of Example 1 is remarkably improved. It is demonstrated that the on-ice braking performance and the dry braking performance of the pneumatic tire of Comparative Example 2 is improved. However, Comparative Example 2 includes no convex portions having a convex shape in the vertical section with respect to the reference plane in the top areas at the front and the rear sides thereof, and further the concave portion includes no flat plane portion. Therefore, both of the on-ice braking performance and the dry braking performance are inferior to those of the pneumatic tire of Example 1.

What is claimed is:

1. A pneumatic tire comprising a tread surface including a land portion in which a plurality of sipes are formed,
wherein each of the sipes includes a reference plane extending in a depth direction of the sipe from a wavy or zigzag line in the surface of the land portion and each of the sipes is formed with a convex portion having a convex shape in a vertical section with respect to the reference plane in a top area at the front side and the rear side thereof.

2. The pneumatic tire according to claim 1, wherein each of the sipes is further formed with a concave portion having a concave shape in the vertical section with respect to the reference plane in atop area at the front side and the rear side thereof,
the concave portion includes a flat plane portion located at the convex portion side as viewed in the depth direction of the sipe extending in the width direction of the sipe,
the convex portion is connected to the flat plane portion.

3. The pneumatic tire according to claim 2, which satisfies the following relationship:
1.1T≦T1≦2T
where “T” denotes ½ length of the amplitude of a wavy or zigzag line in the surface of the land portion, and “T1” denotes a maximum length of the flat plane portion in the sipe width direction.

4. The pneumatic tire according to claim 2, wherein, the concave portion is connected to the end of the flat plane located at the opposite side of the convex portion and has a side wall having an arc-like shape in a cross section protruding to the width direction of the sipe.
